(19) United States
(12) Patent Application Publication
(10) Pub. No.: US 2008/0266445 A1
(43) Pub. Date: Oct. 30, 2008

(54) INFRA-RED CLOSED CIRCUIT TELEVISION CAMERA HAVING REFLECTION PLATE

(76) Inventor: Min Soo Park, Kyungki-do (KR)

Correspondence Address: MARC E. HANKIN, ESQ., 11414 THURSTON CIRCLE, LOS ANGELES, CA, 90049, US

(21) Appl. No.: 11/868,946

(22) Filed: Oct. 8, 2007

(30) Foreign Application Priority Data
Apr. 30, 2007 (KR) 10-20-2007-7104

(51) Int. Cl. H04N 5/225; H04N 5/33; H04N 7/18; H04N 5/222

(52) U.S. Cl. 348/370; 348/373; 348/143; 348/164; 348/E05.024; 348/E05.029

(57) ABSTRACT

The invention relates to an Infra Red Closed Circuit Television (IR CCTV) surveillance camera equipped with IR LEDs, having a case and a lens section installed in the case's interior. The IR CCTV camera includes a separate LED plate installed with infra-red LEDs, installed in the case in front of the lens section. A reflection plate enables increased efficiency of the IR light, which irradiates from the IR LEDs, and is concentrated on the subjects. Furthermore the reflection plate enables a reduction in the numbers of IR LEDs required for illumination.

### FIELD OF INVENTION

This invention relates, generally, to Infra-Red Closed Circuit Television (IR CCTV) cameras; more particularly to IR CCTV cameras equipped with IR Light Emitting Diodes (LEDs) that can irradiate IR light on a subject.

This application claims priority to the Korean Application for Patent Number 10-20-2007-7104 filed on Apr. 30, 2007, for Infra-Red Closed Circuit Television Having Reflection Plate, the contents of which are incorporated herein by reference in their entirety.

### BACKGROUND

Generally, CCTV (Closed Circuit Television) surveillance cameras are installed along walls or ceilings of public buildings, financial institutions, or residential areas, viewing and recording situations for the purpose of monitoring the passers by.

Infra-Red Closed Circuit Television (IR CCTV) surveillance cameras enable recording when there is no visible light, during nighttime or in dark places or other situations in which monitoring is difficult. The IR CCTV surveillance camera is equipped with IR LEDs around its lens sections that emit IR light, making it possible to capture images at nighttime.

FIG. 1 illustrates a known IR CCTV surveillance camera of the prior art. It generally includes IR LEDs 11 installed in an LED plate 10 fixed on the case 2, emitting IR light for irradiating subjects. The LED plate 10 has a planar flat board form.

However, the known IR CCTV surveillance camera of FIG. 1 using known technology has the following problems.

Existing IR CCTV surveillance cameras using known technology generally use a large number of IR LEDs 11, up to 150 individual IR LEDs. There was no separate technology available to collect the IR light irradiated on a subject, or prevent the loss of IR light irradiated away from the subject.

So many IR LEDs 11 are needed in the known technology, that known IR CCTV surveillance cameras have the problem of increasing production costs.

In addition, for the above IR LEDs, the numerous numbers of IR LEDs created the problem of poor aesthetic appearance.

### SUMMARY OF THE INVENTION

Embodiments of the device are designed to irradiate subjects by collecting IR light according to distances to the subjects, so that subjects can be illuminated, while minimizing the loss of IR light, allowing IR light to be emitted along the entirety of the subjects. An infra red closed-circuit television (IR CCTV) camera according to the present invention includes a reflection plate that is designed to minimize the numbers of IR LEDs required for illumination, and thus, lower production costs.

The IR CCTV surveillance camera, with the reflection plate that is designed to achieve the above purposes, includes a case and a lens section installed in the case's interior. The IR CCTV camera includes a separate LED plate installed with infra-red LEDs, installed in the case in front of the lens section. The reflection plate enables increased efficiency of the IR light, which irradiates from the IR LEDs, and is concentrated on the subjects. Furthermore the reflection plate enables a reduction in the numbers of IR LEDs required for illumination.

The reflection plate has the feature of multiple LED holes which are configured to have the IR LEDs inserted therethrough. The reflection plate symmetrically expands around the LED hole, and it expands increasingly open in the subject's direction, to make the radius of curvature larger in the subject's direction, extending from the LED hole. Depending on the location of the IR LEDs, the reflection plate features a configuration that presents the reflection section such that it can disperse or concentrate light that irradiates from the IR LEDs. The reflection plate features curves that bend in toward the LED hole in a concave form toward its interior.

The reflection plate in this design includes a protrusion on its outside circumference, a projection rim that is created to increase the light concentration's efficiency in illuminating a subject. The reflection plate's entire front is coated with a reflective coating material.

Other features and advantages of this invention will become apparent from the following description of several embodiments of the invention, taken in conjunction with the accompanying drawings, which illustrate, by way of example, the principles of the invention.

### BRIEF DESCRIPTION OF THE DRAWINGS

FIG. 1 is a perspective view of the exterior configuration of a known IR CCTV surveillance camera of the prior art.

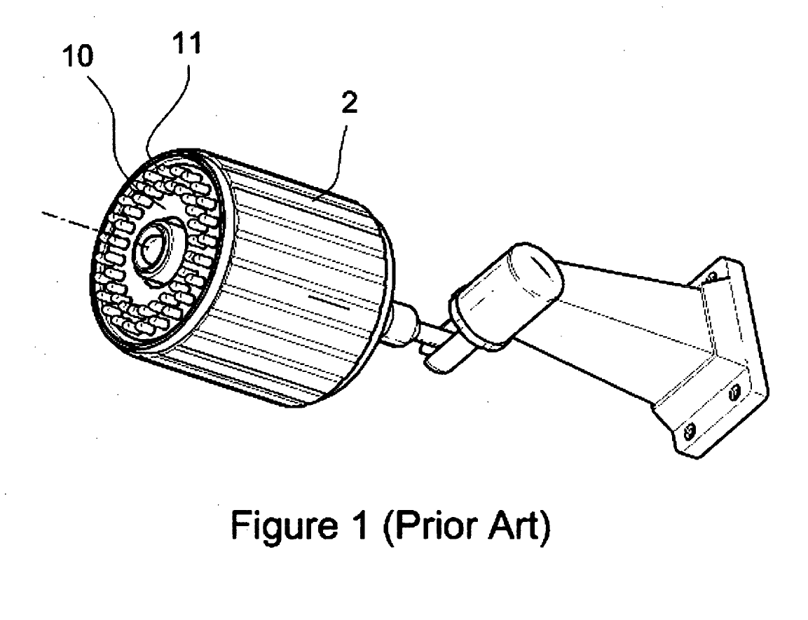

FIG. 2 is an exploded perspective view of an embodiment of an IR CCTV surveillance camera according to the present invention.

FIG. 3 is a perspective view of the reflection plate illustrated in FIG. 2.

FIG. 4 is a cross-sectional view of the reflection plate of FIG. 3 taken along line A-A.

FIG. 5 is an operational view of the reflection plate illustrated in FIG. 4.

FIG. 6 is another operational view of the reflection plate illustrated in FIG. 4.

### DRAWINGS—REFERENCE NUMERALS

102: Case
110: Lens section
150: LED board
151: IR LEDs
160: Reflection plate
161: LED hole
162: Reflection section
163: Projection rim

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “surveillance camera” or “camera” refers to any type of “optical device,” and “IR LEDs” refers to any device that is used to produce light, including lamps, individual LEDs, and arrays of multiple LEDs.

The following is an exemplary usage of the IR CCTV surveillance camera with the reflection plate described in detail by reference to the attached Figures.

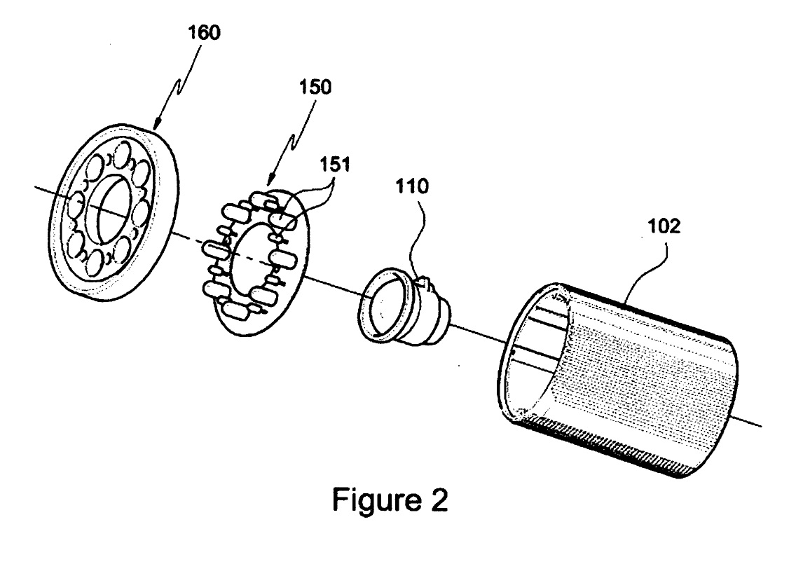

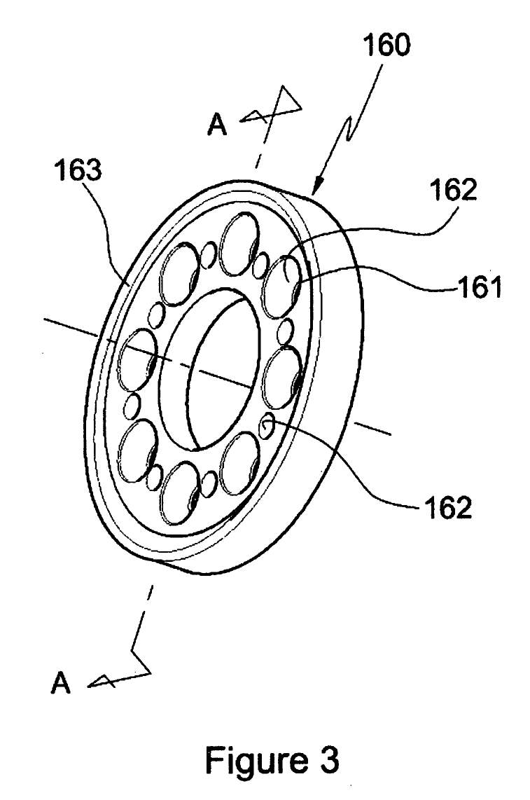

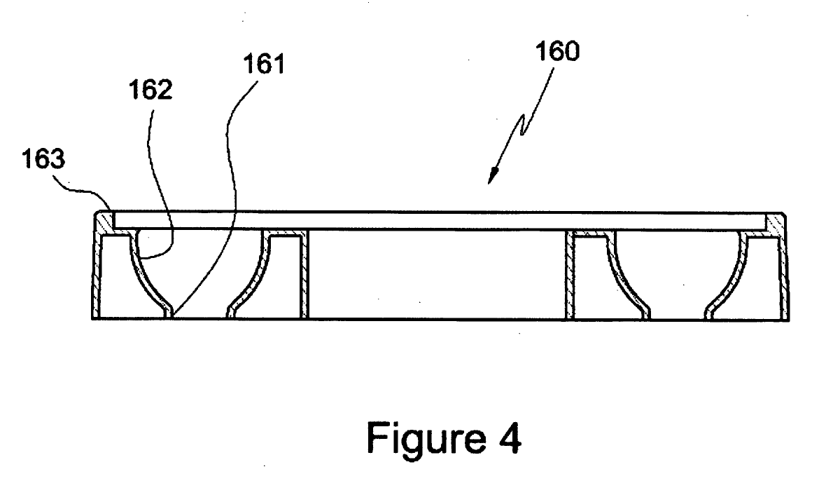

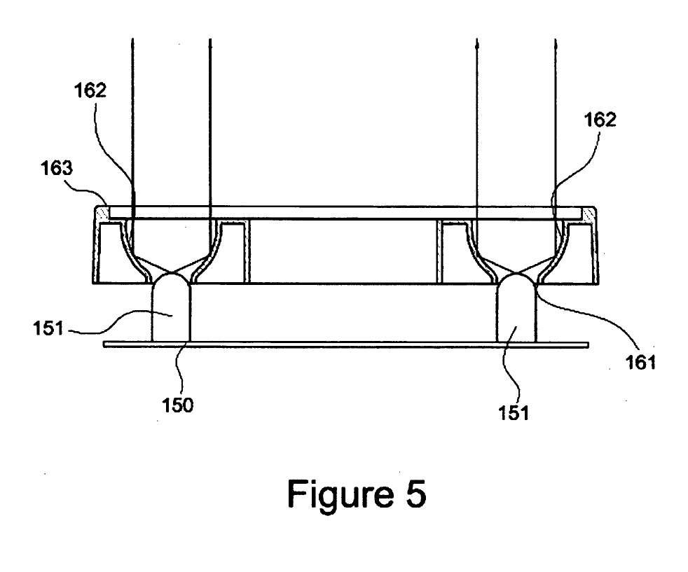

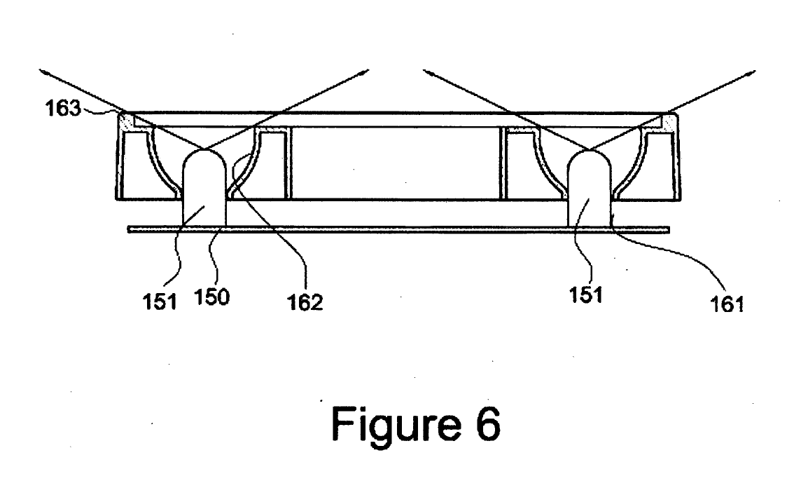

FIG. 2 illustrates an exploded perspective view of the infra-red closed circuit television, or surveillance camera, having a reflection plate. FIG. 3 illustrates a detailed view of the reflection plate illustrated in FIG. 2. FIG. 4 illustrates a sectional view of the reflection plate of FIG. 3 along line A-A, and FIGS. 5 and 6 illustrate operational conceptual diagrams of the reflection plate according to FIG. 3.

As illustrated in FIGS. 2-6, the camera having a reflection plate includes case 102, and lens section 110 installed inside the case 102. The camera features reflection plate 160 that configures and includes LED plate 150 installed with infra-red light emitting diodes (IR LEDs) 151.

The reflection plate 160 is separate from the IR LEDs 151 in a direction toward the subject, i.e., forward toward the front side, and installed in the case 102. The reflection plate 160 performs the function of increasing the efficiency of IR light concentration on subjects that are irradiated by the IR LEDs 151.

FIG. 3 illustrates that in the reflection plate 160, multiple LED holes 161 are formed to accommodate the IR LEDs 151 inserted to face forward.

The reflection plate 160 symmetrically expands around the LED hole 161, and it expands open to make the radius of curvature increase from the LED hole in the subject's direction. Depending on the forward/rearward locations of the IR LEDs 151 in relation to the reflection plate 160, the reflection plate 160 features a configuration that overlaps more or less of the reflection section 162 with the IR LEDs 151, which disperses or concentrates the irradiated IR light that radiates from the IR LEDs 151.

The following includes more detailed descriptions of the structure and configuration of the reflection section 162.

FIGS. 4-6 illustrate the reflection section 162 symmetrically expanding around the LED hole 161, while expanding open in a forward direction (upward as illustrated in FIGS. 4-6) to cause the radius of curvature to become larger in the subject's direction from the LED hole 161. The curvature formed from the LED hole 161 along the reflection section 162 is concave toward its interior.

The reflection plate 160 includes a protrusion along its outer circumference forming a projection rim. The projection rim 163 is equipped to increase the light concentration efficiency on a subject.

The projection rim 163 functions to collect the reflected IR light, so it increases the IR light's light concentration efficiency.

The front side of the reflection plate 160 includes a reflection coating material, coated on to reflect light.

The following describes the functions of the IR CCTV surveillance camera with the reflection plate in this design.

As illustrated in FIGS. 5 and 6, the IR LEDs 151 go through the reflection plate 160's LED holes 161, situating the IR LEDs 151 in the reflection section 162.

As illustrated in FIG. 5, when subjects are situated at far distances, if IR LEDs 151 are located in the rear of the reflection plate 160's reflection section 162, it creates an IR beam as illustrated FIG. 5, and it collects the beams to arrive at the distant subject.

As a result, even when subjects are distant, the reflection plate 160 provides the benefit of irradiating IR light with ample intensity using a relatively small number (22˜24 were used in this example) of IR LEDs 151.

When subjects are at close distances, if IR LEDs 151 are located in front of the reflection plate 160's reflection section 162, as illustrated in FIG. 6, the emitted light is not concentrated by the reflection section 162, and the IR beam is dispersed to irradiate IR light on the entirety of the subject at close distances.

As a result, even when subjects are at close distances, illuminating the entire subject at close distances is possible, while using only a relatively small number (22˜24 were used in this example) of IR LEDs 151, and irradiating IR light on the entire subject is possible.

The LED plate 150, equipped with the IR LEDs 151, can be fixed on the CCTV camera's case, or, it can be configured to move back and forth in relation to the reflection plate 160. Additionally, the reflection plate 160 can be configured to move back and forth in relation to the IR LEDs 151.

The actual operational example of the above device is only exemplary of the above design's technological concept, and modified operational examples are within the scope of this device's technology.

### BENEFITS OF THE INVENTION

Embodiments of the IR CCTV surveillance camera having the reflection plate design providing the configuration and functions as described above have the following benefits.

First, installing the reflection plate 160 including the reflection section 162 and the LED hole 161 in front of the LED plate 150, enables the benefit of irradiating by focusing and concentrating IR light depending on the subject's distance from the IR light source, concentrating or dispersing the IR light accordingly for optimal irradiating.

As a result, loss of IR light is minimized, providing the benefit of irradiating IR light on the entire subject.

Second, in situations described above wherein loss of IR light is minimized, IR light is irradiated on the entire subject, enabling the camera to take images without using a large number of IR LEDs. Therefore, the number of IR LEDs is reduced, providing the benefit of lowering the surveillance camera's production costs.

Third, by reducing the numbers of IR LEDs needed, the camera has the benefit of substantially improving the camera's appearance.

Fourth, the projection rim 163 described above provides the benefit of increasing the IR beam's rate of light concentration.

While multiple embodiments are disclosed, still other embodiments of the present invention will become apparent to those skilled in the art from the foregoing detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention. Various embodiments of the invention remain useable in tandem or combination of one another.

What is claimed is:

1. An Infra-Red Closed Circuit Television surveillance camera, comprising:
a case;
a lens section installed inside the case;
an LED plate equipped with Infra-Red LEDs, separately installed forward of the lens section; and
a reflection plate separately installed forward of the LED plate, wherein:
the reflection plate is separable from the Infra-Red LEDs in a forward direction to increase the efficiency of light concentration irradiated from the Infra-Red LEDs and concentrated on a subject.

2. The camera of claim 1, wherein:
the reflection plate includes multiple LED holes configured to receive the Infra-Red LEDs inserted therethrough in the forward direction.

3. The camera of claim 2, wherein:
the reflection plate symmetrically expands around the LED holes, expanding open in the forward direction to create a radius of curvature that becomes larger in the forward direction away from the LED holes, thereby forming reflection sections; wherein:
the reflection sections are configured to disperse the light irradiated from the Infra-Red LEDs when the Infra-Red LEDs are in a forward position; and
the reflection sections are configured to concentrate the light irradiated from the Infra-Red LEDs when the Infra-Red LEDs are in a rearward position.

4. The camera of claim 3, wherein:
the reflection plate features curves that bend in toward the LED hole in a concave form toward its interior.

5. The camera of claim 4, wherein:
the reflection plate includes a protrusion along its forward outer circumference forming a projection rim, wherein the projection rim is configured to increase light concentration efficiency on a subject.

6. The camera of claim 5, wherein:
the reflection plate further includes a reflection coating material coated on the front of the reflection plate to reflect light.
